(19) United States
(12) Patent Application Publication
(10) Pub. No.: US 2009/0267036 A1
(43) Pub. Date: Oct. 29, 2009

(54) MOVING DEVICE

(75) Inventors: GARY W. ANDERSON, PUYALLUP, WA (US); KEVIN L. SALT, MOUNT VERNON, WA (US)

Correspondence Address: ROZENBLAT IP LLC;AND THE BOEING COMPANY, 300 West Adams Street, Suite 505, CHICAGO, IL, 60606, US

(73) Assignee: THE BOEING COMPANY, CHICAGO, IL (US)

(21) Appl. No.: 12/109,097

(22) Filed: Apr. 24, 2008

(51) Int. Cl. B66F 3/08

(52) U.S. Cl. 254/100

(57) ABSTRACT

A support unit for moving an object may include an elongated member, at least one suction device coupled to the elongated member for attaching to an object, a lifting mechanism for raising and lowering the elongated member and an attached object, and a rotating member for moving the support unit and the attached object from a departure location to a destination location.

### BACKGROUND

Heavy objects, such as aircraft monuments comprising galleys, lavatories or other types of objects, often need to be moved from one location to another location. Some of the prior art systems and/or methods for moving heavy objects utilize carts, dollies, modified hand trucks, and/or hand-carried using suction cups. However, this may be difficult, costly, timely, inefficient, experience ergonomic issues, and/or have one or more other types of problems.

A device and/or method is needed to decrease one or more problems associated with one or more of the existing devices and/or methods for moving objects.

### SUMMARY

In one aspect of the disclosure, a support unit for moving an object is provided. The support unit includes: an elongated member having an upper end and a lower end; at least one suction device attached to the elongated member between the upper end and the lower end for attaching to an object; a lifting mechanism attached to the elongated member for raising and lowering the elongated member, the at least one suction device, and an object attached to the at least one suction device; and a rotating member for moving the elongated member, the at least one suction device, and the object attached to the at least one suction device.

In another aspect of the disclosure, a method is provided of moving an object. In one step, at least one support unit is provided comprising an elongated member, at least one suction device attached to the elongated member, a lifting mechanism, and a rotating member. In another step, the at least one suction device is attached to the object at a departure location. In an additional step, the lifting mechanism is raised at the departure location to lift the object attached to the at least one suction device. In still another step, the lifted object attached to the at least one suction device is moved from the departure location to a destination location. In another step, the lifting mechanism is lowered at the destination location to lower the object attached to the at least one suction device.

In still another aspect of the disclosure, a system for moving an object includes a plurality of support units. Each support unit comprises: an elongated member having an upper end and a lower end; at least one attachment device for attaching to an object, wherein the at least one attachment device is attached to the elongated member between the upper end and the lower end; a rotating member for moving the elongated member, the at least one attachment device, and a raised object attached to the at least one attachment device; and a lifting mechanism attached between the elongated member and the rotating member for raising and lowering the elongated member, the at least one attachment device, and a raised object attached to the at least one attachment device.

These and other features, aspects and advantages of the disclosure will become better understood with reference to the following drawings, description and claims.

### BRIEF DESCRIPTION OF THE DRAWINGS

FIG. 1 shows a perspective view of a system attached to an object at a departure location, wherein the system may be used to move the object;

FIG. 2 shows a flowchart of one embodiment of a method for moving an object from a departure location to a destination location;

FIG. 3 shows a perspective view of the system of FIG. 1 having been raised at the departure location to raise the attached object;

FIG. 4 shows a perspective view of the raised system and attached object of FIG. 3 having been moved from the departure location to the destination location;

FIG. 5 shows a perspective view of the system and attached object of FIG. 4 having been lowered at the destination location; and

FIG. 6 shows a perspective view of the object of FIG. 5 located at the destination location with the system detached from the object.

### DETAILED DESCRIPTION

The following detailed description is of the best currently contemplated modes of carrying out the disclosure. The description is not to be taken in a limiting sense, but is made merely for the purpose of illustrating the general principles of the disclosure, since the scope of the disclosure is best defined by the appended claims.

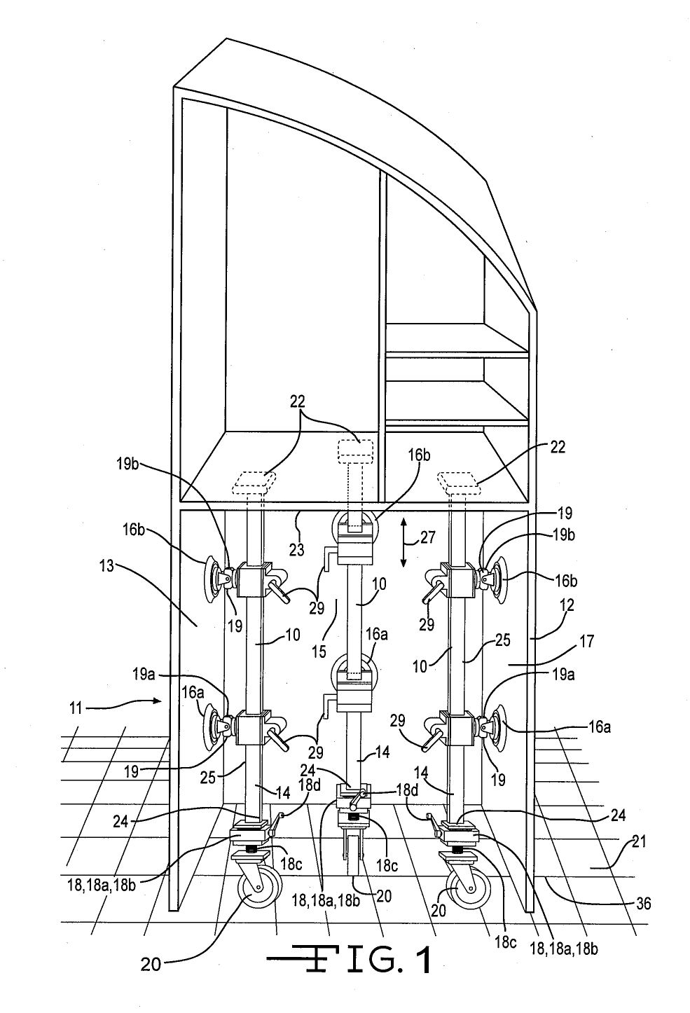

FIG. 1 shows a perspective view of a system 11 for moving an object 12. The system 11 may comprise a plurality of support units 10. Each of the support units 10 may be attached to separate sides 13, 15, and 17 of the object 12. In other embodiments, any number of support units 10 may be aligned in varying orientations and/or configurations relative to varying non-side surfaces of an object 12 in order to move the object 12. The support units 10 may be used to move an object 12 comprising at least one of an aircraft monument, an aircraft part, an airplane galley, and an airplane lavatory. In other embodiments, any number, type, size, configuration, and/or orientation of support units 10 may be used to move varying types of airplane and/or non-airplane objects. For instance, one, two, three, four, or more support units 10 may be used to move an object 12 comprising an aircraft monument, an aircraft part, an airplane galley, an airplane lavatory, or other type of object.

Each support unit 10 may include an elongated member 14, a plurality of suction devices 16a and 16b, a lifting mechanism 18, and a rotating member 20. It is preferable that two or more suction devices 16a and 16b be utilized. However, in other embodiments, one or more of the support units 10 may include any number, size, type, and/or configuration of elongated members 14, suction devices 16a and 16b, lifting mechanisms 18, and/or rotating members 20.

Each elongated member 14 may include an upper end 22 and a lower end 24. The upper end 22 of the elongated member 14 may be adapted to be disposed against a surface 23 of the object 12 in order to help support the object 12. The suction devices 16a and 16b may be coupled through swivel devices 19a and 19b to one side 25 of the elongated member 14 between the upper end 22 and the lower end 24. The swivel devices 19a and 19b may allow the suction devices 16a and 16b to swivel relative to the elongated member 14 to properly orient the suction devices 16a and 16b against the object 12.

The suction devices 16a and 16b may be slide-ably connected to the elongated member 14 to allow the suction devices 16a and 16b to be moved relative to and along the elongated member 14. Each suction device 16a and 16b may be adapted to be locked and unlocked from their positions against the elongated member 14 using one or more locking devices 29. In such manner, the position of the suction devices 16a and 16b may be changed relative to the elongated member 14 in order to align the suction devices 16a and 16b with the appropriate surface(s) of the object 12. The suction devices 16a and 16b of each support unit 10 may be adapted to be attached to various sides 13, 15, and 17 of the object 12 using vacuum suction. In other embodiments, varying non-suction types of attachment devices may be utilized in order to attach the support units 10 to varying surfaces of the object 12. Each suction device 16a and 16b may be attached to a level device 19 for leveling the object 12.

Each lifting mechanism 18 may be attached between the lower end 24 of the elongated member 14 and the rotating member 20. The lifting mechanism 18 may be adapted to raise and lower the elongated member 14 and/or an object 12 attached to the suction devices 16a and 16b. The lifting mechanism 18 may comprise a jacking member 18a comprising one or more of a gear drive 18b, a jack screw 18c, a crank 18d, and/or another type of lifting mechanism as known in the art for raising and lowering the elongated member 14. The lifting mechanism 18 may be adapted to jack up and/or jack down the attached elongated member 14 along direction 27 by a user applying manual labor to the lifting mechanism 18 without using a battery, electricity, and/or another power source. For instance, a user may manually rotate the crank 18d in order to lift and/or lower the elongated member 14 along direction 27 relative to the jack screw 18c using the gear drive 18b. In such manner, by rotating the crank 18d, the position of the elongated member 14, the attached suction devices 16a and 16b, and the object 12 attached to the suction devices 16a and 16b may be raised or lowered. The rotating member 20 may comprise one or more wheels attached to the lifting mechanism 18 near and/or at the lower end 24 of the elongated member 14. The rotating member 20 may be adapted to rotate to move the support unit 10 and a raised object 12 attached to the suction devices 16a and 16b from one position to another position in order to change the location of the object 12 relative to a surface 21 such as the ground or another type of surface.

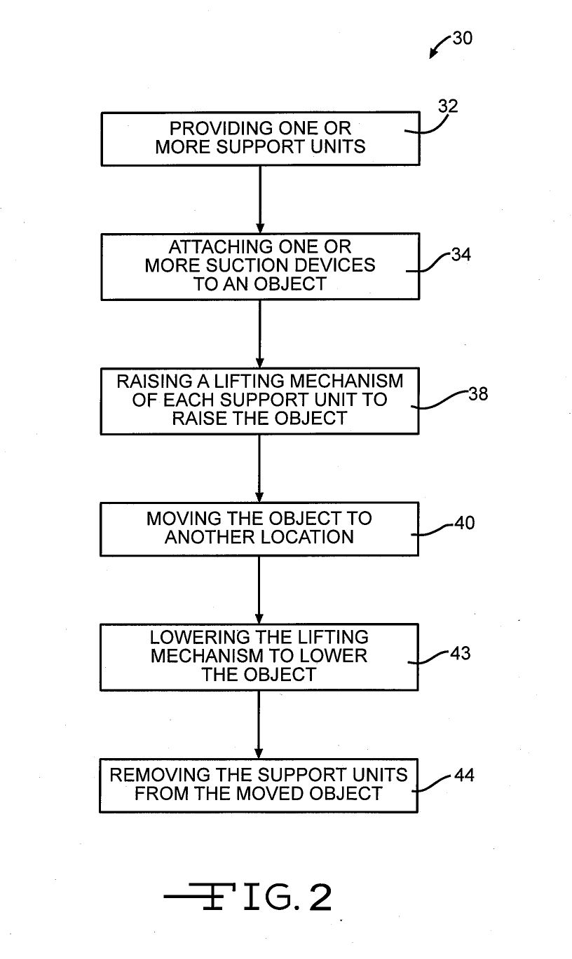

FIG. 2 shows a flowchart of one embodiment of a method 30 for moving an object 12. The object 12 moved under the method 30 may comprise an aircraft monument, an aircraft part, an airplane galley, an airplane lavatory, another type of airplane object, and/or a non-airplane object. In one step 32, one or more support units 10 may be provided. In one embodiment, as shown in FIG. 1, a plurality of support units 10 may be provided. In other embodiments, any number of support units 10 may be provided and used to move the object 12. For instance, one, two, three, four, five, or any number of support units 10 may be used to move the object 12.

Each support unit 10 may include: an elongated member 14 having an upper end 22 and a lower end 24; at least one suction device 16a and/or 16b coupled through swivels 19a and 19b to one side 17 of the elongated member 14 between the upper end 22 and the lower end 24; a lifting mechanism 18 coupled to the elongated member 14 comprising a jacking member 18a including one or more of a gear drive 18b, a jack screw 18c, a crank 18d, and/or another type of lifting mechanism; and at least one rotating member 20 comprising one or more wheels. The lifting mechanism 18 may be attached between the elongated member 14 and the rotating member 20. In other embodiments, each support unit 10 may comprise any of the embodiments disclosed herein. In still other embodiments, each support unit 10 may include any number, size, type, and/or configuration of elongated members 14, suction devices 16a and 16b, lifting mechanisms 18, and/or rotating members 20.

In another step 34 of the method of FIG. 2, the at least one suction device 16a and/or 16b of each support unit 10 may be attached to the object 12 at a departure location 36 along the surface 21 as shown in FIG. 1. The suction devices 16a and 16b of each respective support unit 10 may be attached to various sides 13, 15, and 17 of the object 12. During step 34, the lifting mechanisms 18 of each support unit 10 may be lowered and the suction devices 16a and 16b of each support unit 10 may be attached to the sides 13, 15, and 17 of the object 12 using vacuum suction pressure. Step 34 may further comprise sliding the at least one suction device 16a and/or 16b relative to the elongated member 14 and locking the at least one suction device 16a and/or 16b in place relative to the elongated member 14 using one or more locking devices 17. Step 34 may additionally comprise swiveling the at least one suction device 16a and/or 16b relative to the elongated member 14 using at least one swivel device 19a and/or 19b.

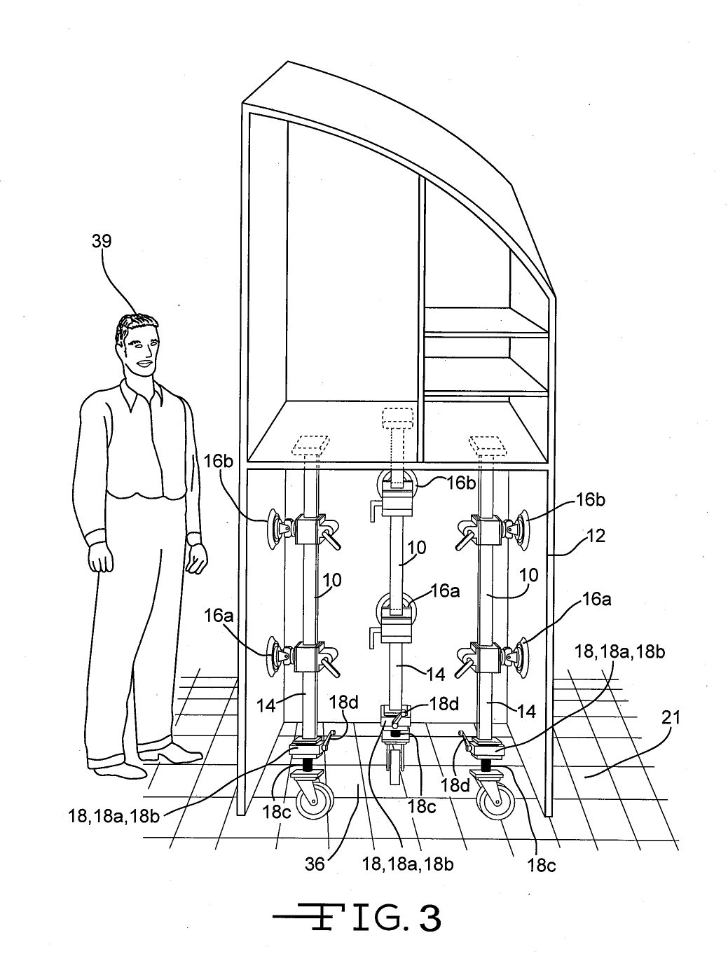

In an additional step 38 of the method of FIG. 2, the lifting mechanism 18 of each support unit 10 may be raised at the departure location 36 to lift the object 12 attached to the at least one suction device 16 and/or 16b off the surface 21 as shown in FIG. 3. Step 38 may comprise a user 39 manually rotating the crank 18d to lift the elongated member 14 relative to the jack screw 18c using the gear drive 18b.

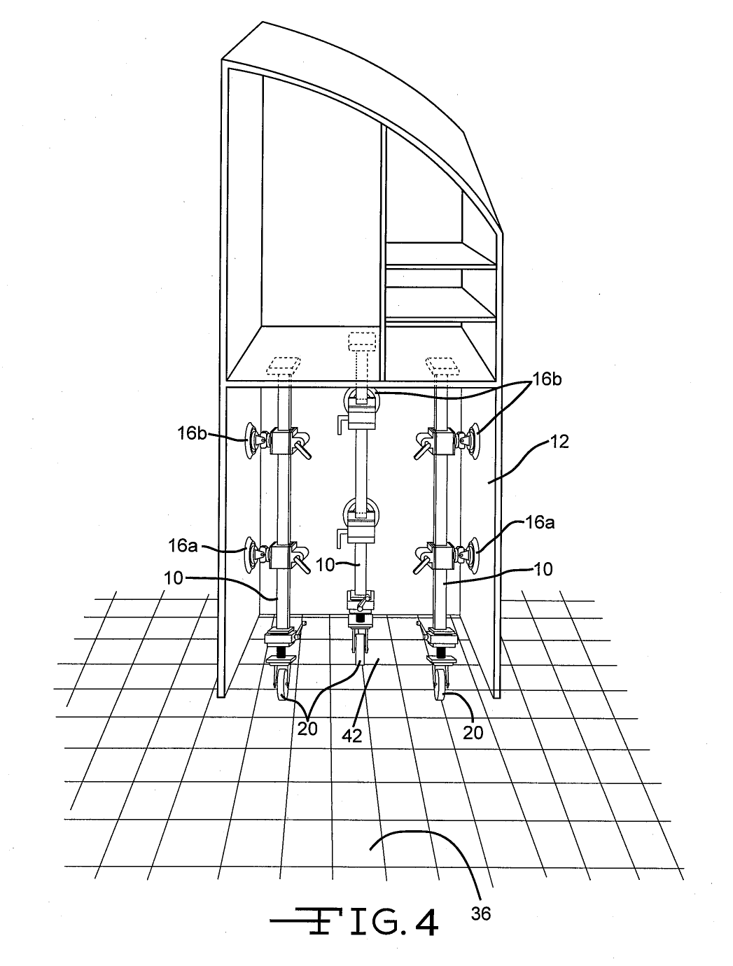

In still another step 40 of the method of FIG. 2, the lifted object 12 attached to the at least one suction device 16a and/or 16b of each support unit 10 may be moved from the departure location 36 to a destination location 42 by rotating the rotating member 20 of each support unit 10 as shown in FIG. 4.

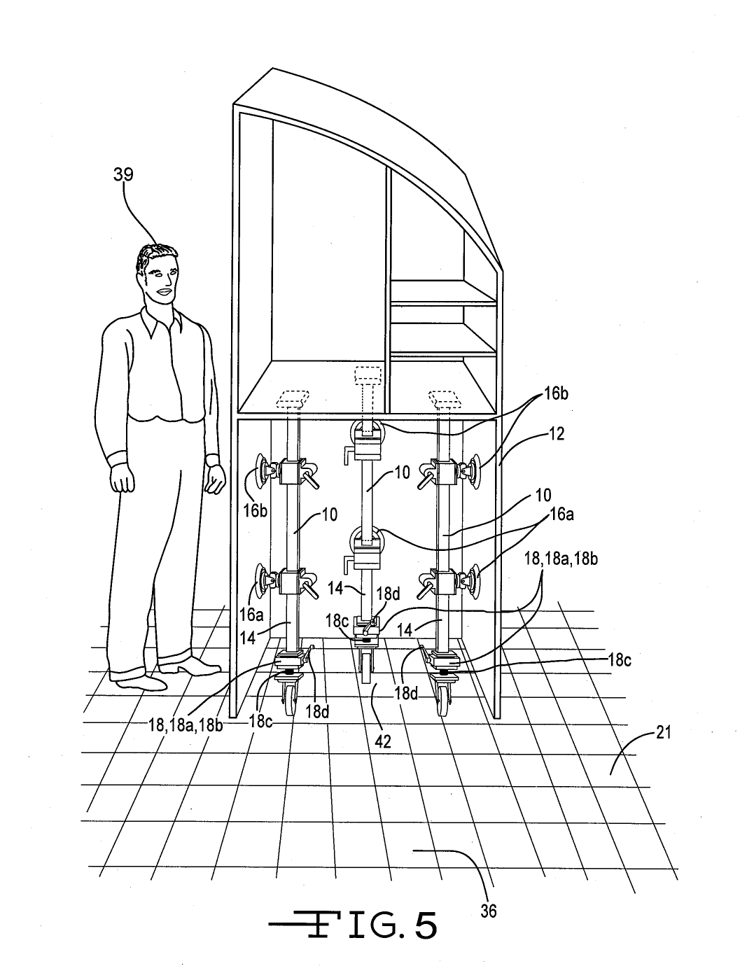

In yet another step 43 of the method of FIG. 2, the lifting mechanism 18 of each support unit 10 may be lowered at the destination location 42 to lower the object 12 attached to the at least one suction device 16a and/or 16b at the destination location 42 as shown in FIG. 5. Step 43 may comprise the user 39 manually rotating the crank 18d to lower the elongated member 14 relative to the jack screw 18c using the gear drive 18b. In such manner, the object 12 may be moved from the departure location 36 along surface 21 to the destination location 42 along surface 21.

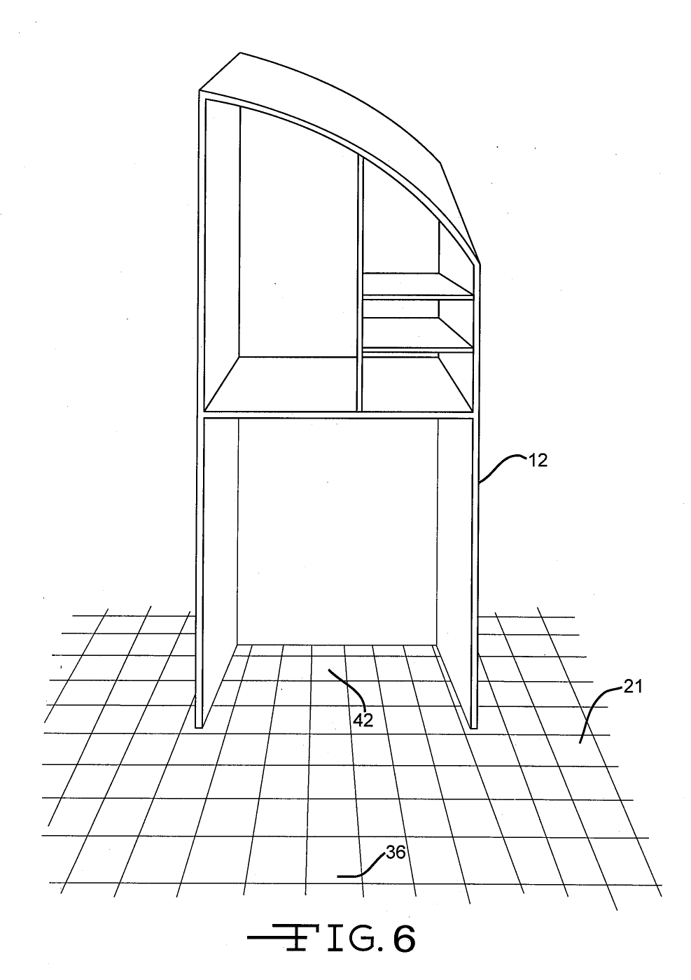

In an additional step 44 of the method of FIG. 2, the support units 10 may be removed from the object 12 at the destination location 42 to leave the object 12 disposed at the destination location 42 along surface 21 as shown in FIG. 6.

One or more embodiments of the disclosure may reduce one or more problems of one or more of the prior art systems and/or methods for moving objects by making it easier to move an object, making it less costly to move an object, making it quicker to move an object, making it more efficient to move an object, reducing injury as a result of moving an object, and/or reducing one or more other types of problems.

It should be understood, of course, that the foregoing relates to exemplary embodiments of the disclosure and that modifications may be made without departing from the spirit and scope of the disclosure as set forth in the following claims.

1. A support unit for moving an object comprising:
an elongated member having an upper end and a lower end;
at least one suction device for attaching to an object, wherein the at least one suction device is attached to the elongated member between the upper end and the lower end;
a lifting mechanism attached to the elongated member for raising and lowering the elongated member, the at least one suction device, and an object attached to the at least one suction device; and
a rotating member for moving the elongated member, the at least one suction device, and the object attached to the at least one suction device.

2. The support unit of claim 1 wherein the support unit is for moving an object comprising at least one of an aircraft monument, an aircraft part, an airplane galley, and an airplane lavatory.

3. The support unit of claim 1 wherein a plurality of suction devices are attached to one side of the elongated member between the upper end and the lower end.

4. The support unit of claim 1 wherein the at least one suction device is slide-ably connected to the elongated member to allow the at least one suction device to slide along the elongated member.

5. The support unit of claim 4 further comprising at least one locking device for locking and unlocking the at least one suction device to the elongated member.

6. The support unit of claim 1 further comprising at least one swivel device for swiveling the at least one suction device relative to the elongated member.

7. The support unit of claim 1 further comprising a level device for leveling the object.

8. The support unit of claim 1 wherein the at least one suction device is adapted to use vacuum pressure to attach to an object.

9. The support unit of claim 1 wherein the lifting mechanism is attached between the elongated member and the rotating member.

10. The support unit of claim 1 wherein the lifting mechanism comprises a jacking member.

11. The support unit of claim 10 wherein the jacking member comprises at least one of a gear drive, a jack screw, and a crank.

12. The support unit of claim 11 wherein the jacking member includes each of a gear drive, a jack screw, and a crank, and the elongated member is adapted to be jacked up and down relative to the jack screw using the gear drive as a result of a user rotating the crank.

13. The support unit of claim 1 wherein the rotating member comprises at least one wheel.

14. A method of moving an object comprising:
providing at least one support unit comprising an elongated member, at least one suction device attached to the elongated member, a lifting mechanism, and a rotating member;
attaching the at least one suction device to the object at a departure location;
raising the lifting mechanism at the departure location to lift the object attached to the at least one suction device;
moving the lifted object attached to the at least one suction device from the departure location to a destination location; and
lowering the lifting mechanism at the destination location to lower the object attached to the at least one suction device.

15. The method of claim 14 wherein the object comprises at least one of an aircraft monument, an aircraft part, an airplane galley, and an airplane lavatory.

16. The method of claim 14 wherein the providing step comprises providing a plurality of support units, the attaching step comprises attaching the at least one suction device of each support unit to the object at the departure location, the raising step comprises raising the lifting mechanism of each support unit at the departure location to lift the object attached to the suction devices, the moving step comprises moving the lifted object attached to the suction devices from the departure location to the destination location by rotating the rotating members of the support units, and the lowering step comprises lowering the lifting mechanisms of the support units at the destination location to lower the object attached to the suction devices.

17. The method of claim 16 wherein the attaching step comprises attaching each support unit to a different surface of the object.

18. The method of claim 16 wherein each support unit comprises a plurality of suction devices.

19. The method of claim 14 wherein the attaching step comprises sliding the at least one suction device relative to the elongated member, and locking the at least one suction device in place relative to the elongated member using a locking device.

20. The method of claim 14 wherein the attaching step comprises swiveling the at least one suction device relative to the elongated member using at least one swivel device.

21. The method of claim 14 wherein the attaching step attaches the at least one suction device to the object using vacuum pressure.

22. The method of claim 14 wherein the provided lifting mechanism is attached between the provided elongated member and the provided rotating member.

23. The method of claim 14 wherein the provided lifting mechanism comprises a jacking member.

24. The method of claim 23 wherein the jacking member comprises at least one of a gear drive, a jack screw, and a crank.

25. The method of claim 23 wherein the jacking member includes each of a gear drive, a jack screw, and a crank, the raising step further comprises a user manually rotating the crank to lift the elongated member relative to the jack screw using the gear drive, and the lowering step further comprises the user manually rotating the crank to lower the elongated member relative to the jack screw using the gear drive.

26. The method of claim 23 wherein the rotating member comprises at least one wheel.

27. A system for moving an object comprising:
a plurality of support units wherein each support unit comprises:
an elongated member having an upper end and a lower end;
at least one attachment device for attaching to an object, wherein the at least one attachment device is attached to the elongated member between the upper end and the lower end;
a rotating member for moving the elongated member, the at least one attachment device, and a raised object attached to the at least one attachment device; and
a lifting mechanism attached between the elongated member and the rotating member for raising and lowering the elongated member, the at least one attachment device, and a raised object attached to the at least one attachment device.

28. The system of claim 27 wherein the at least one attachment device comprises at least one suction device.
